(19) United States
(12) Patent Application Publication
(10) Pub. No.: US 2004/0111702 A1
(43) Pub. Date: Jun. 10, 2004

(54) Method and apparatus for visual programming

(76) Inventor: Kin Ming Chan, Toronto (CA)

Correspondence Address: T. Andrew Currier, Lang Michener, BCE Place, Suite 2500, 181 Bay Street, Toronto, M5J 2T7, CA

(21) Appl. No.: 10/315,205

(22) Filed: Dec. 10, 2002

(51) Int. Cl. G06F 9/44

(52) U.S. Cl. 717/113; 717/105; 717/109

(57) ABSTRACT

A method and apparatus for visual programming is provided. A domain model consisting of a set of object classes and a set of relationships therebetween, said sets of object classes and relationships having a set of attributes, is received and analyzed. An order of generation for the code modules is determined and each of the object classes is matched to at least one shell forming a basis for one of a set of code modules for implementation of the domain model. The attributes and relationships are then matched with template code blocks inserted into the shells. The code modules are generated by inserting the template code blocks into the shells according to the generation order.

### FIELD OF THE INVENTION

The present invention relates generally to computer programming, and more particularly relates to a method and apparatus for visual programming.

### BACKGROUND OF THE INVENTION

As is well known to those of skill in the art, programming languages provide a high-level standard set of programming instructions that can be compiled or interpreted into a machine language specific to the hardware on which the software is being executed. Some more recent programming language tools are so-called visual programming tools, which allow the programmer to use graphical structures to represent the software and/or data object classes they are creating, rather than using text-based structures.

Many of these tools employ the Unified Modeling Language (“UML”) to allow programmers to graphically specify object-oriented software models or object models. UML is becoming an industry-standard language for specifying, visualizing, constructing, and documenting the artefacts of software systems. It simplifies the complex process of object model design, allowing the modeling of a “blueprint” for construction. Detailed information on UML can be found at http://www.omg.org/uml. UML has proven to be particularly useful in the construction of object class models when planning and deploying certain enterprise applications using Java 2 Enterprise Edition (“J2EE”) from Sun Microsystems, or the like. Typically, the process begins with the design of a domain model, an object class model that represents one or more sets of real-world objects and the relationships therebetween. The domain model, designed in UML, is then typically used by the developer to design a less-abstract, implementation-level object model specific to the platform upon which the domain model is to be implemented. Code that is consistent with the domain model is generated from this platform-specific model, either manually or by a programming tool such as Rational Software's Rational Rose.

One disadvantage of this method of implementing domain models for use in enterprise application platforms is that developers typically manually generate one or more intermediate-level models from the high-level UML model before generating code. As the code generation is a manual process, it can be error-prone and time consuming, and lead to different interpretations by individual developers as to how to actually implement the high-level domain model, therefore leading to inconsistent programming techniques and styles in the actual implementation, or requiring a preparation of a detailed protocol as to how high-level UML models are to be implemented.

Some of the foregoing problems can be addressed by developing platform-specific models using code-generating tools from which code can be automatically generated, such as using Rational Software's Rational Rose to automatically generate J2EE compliant code. As these code-generating tools are simple translators, the platform-specific models that a user inputs are typically very “low-level”. Further, as the code is generated from low-level, platform-specific models that do not typically allow a user to indicate all of the features that are available in the domain model, the code generated is not generally feature-complete with respect to the domain model, and requires the manual programming of various features. Resultantly, the models nearly approximate pseudo-code, and, as such, can be more meticulous, time-consuming and error-prone to design. Further, significant effort is required to add features to the code generated by such a software package. In addition, certain aspects regarding code generation of the modeling systems used by software packages such as Rational Rose are vendor-specific and, as a result, require programmers to learn a new modeling system from the ground up upon adoption of a new software package.

### SUMMARY OF THE INVENTION

In an aspect of the invention, there is provided a method of visual programming, comprising the steps of: receiving a domain model representing a set of object classes, a set of relationships and a set of attributes; analyzing each of the object classes, relationships and attributes; determining a generation order for a set of code modules to implement the domain model; matching the analyzed object classes with at least one corresponding shell; matching the analyzed relationships and the attributes with at least one corresponding template code block respective to the matched shells; and, generating the set of code modules by inserting the at least one template code block into the shells according to the generation order.

In a particular implementation of the first aspect, the shell is a supported shell.

In a particular implementation of the first aspect, the set of attributes is additionally comprised of at least one implicit attribute.

In another particular implementation of the first aspect, the domain model is modeled via the Unified Modeling Language.

In a particular implementation of the first aspect, the step of analyzing each of the object classes, attributes and relationships comprises the steps of: analyzing the types of the object classes; analyzing the attributes of the object classes; analyzing the persistence of the object classes; analyzing the cardinality of the relationships; analyzing the direction of the relationships; and, analyzing the composition of the relationships.

Where the code modules implement the domain model on the Java 2 Enterprise Edition platform, the step of matching each of the object classes comprises the steps of: selecting at least one of the shells to implement each of a set of EJBs associated with the object classes; selecting at least one of the shells to implement a deployment descriptor; and, selecting at least one of the shells to implement a database schema.

In a particular implementation of the first aspect, the step of generating the set of code modules comprises the steps of: opening and customizing the shells for the code modules; and, inserting and customizing the at least one template code block into the shells.

In a particular implementation of the first aspect, the code modules consist of executable code.

Some or all of the code modules required to implement the domain model are generated in the step of generating the set of code modules.

In another particular implementation of the first aspect, there are provided the additional steps of: reverse-engineering the set of code modules, the code modules having been customized after the step of generating the set of code modules, to obtain a platform-specific model consisting of a customized set of object classes, relationships and attributes; receiving a set of modifications to the domain model, the modified model having a modified set of object classes, relationships and attributes; analyzing the each of the modified set of object classes, relationships and attributes of the modified domain model; comparing the modified set of object classes, relationships and attributes of the modified domain model to the customized set of object classes, relationships and attributes to identify a set of customizations; merging the set of customizations with the modified set of object classes, relationships and attributes of the modified domain model to produce a customized modified set of object classes, relationships and attributes; and, generating a set of customized modified code modules by performing the steps of determining a generation order, matching the object classes, matching the analyzed relationships, and generating the set of code modules for the customized modified set of object classes, relationships and attributes. The domain model can be modeled via the Unified Modeling Language. Further, the step of reverse-engineering can be performed using a commercial software package.

In a further particular implementation of the first aspect, there are provided the additional steps of: receiving and storing a set of customizations made to the code modules; receiving a set of modifications to the domain model, the modified domain model having a modified set of object classes, relationships and attributes, and generating a modified set of code modules in accordance with the steps of analyzing each of the modified object classes, relationships and attributes, determining a modified generation order for the modified set of code modules, matching the analyzed modified object classes, relationships and attributes, and generating the modified set of code modules; and, inserting the set of customizations into the modified code modules. The customizations can be located between a set of custom comment lines pre-existing in the code modules. The customizations can also be located between a set of custom comment lines added to the code modules during customization. The customizations can be stored by storing the code modules.

In a second aspect of the invention, there is provided an apparatus for visual programming, comprising: a computing device having a central processing unit (CPU), a data storage device for exchanging non-volatile data with the CPU, random access memory (RAM) for exchanging volatile data with the CPU, and an input interface for receiving data for the CPU and an output interface for presenting outputted data from the CPU; the CPU and RAM operable to receive a domain model via the input interface, the domain model being comprised of a set of object classes, a set of relationships and a set of attributes; the CPU being operable to analyze each of the object classes, the attributes and the relationships according to a modeling language used to create the model, the elements being stored in the data storage device and accessible by the CPU; the CPU further operable to determine a generation order for a set of code modules to implement the domain model; the CPU further operable to match the object classes with at least one corresponding shell stored in the data storage device and accessible by the CPU; the CPU further operable to match the analyzed relationships and the analyzed attributes with at least one corresponding template code block respective to the matched shells, the at least one template code block stored in the data storage device and accessible by the CPU; and, the CPU further operable to generate the set of code modules by inserting the template code blocks into the respective shells according to the generation order, and output the generated code modules to at least one of the output interface and the data storage device.

In a particular implementation of the second aspect, the computing device is operable to receive the domain model as a graphical representation.

In a particular implementation of the second aspect, the code modules implement the domain model on a Java 2 Enterprise Edition platform.

In another particular implementation of the second aspect, the computing device is operable to store the code modules on the data storage device.

In a particular implementation of the second aspect, the computing device is operable to compile the code modules to produce executable code.

In a particular implementation of the second aspect, all code modules required to implement the domain model are generated by the CPU.

In a third aspect of the invention, there is provided a method of visual programming, comprising the steps of: receiving a domain model representing a set of object classes and a set of relationships therebetween, the sets of object classes and relationships having a set of attributes; analyzing each of the object classes, attributes and relationships; determining a generation order for the code modules and the template code blocks to be inserted therein; matching each of the object classes to at least one shell, each of the shells forming a basis for one of a set of code modules for implementation of the domain model; matching the attributes and the relationships with at least one template code block for insertion into the shells; and, generating the set of code modules by inserting the template code blocks into the shells according to the generation order.

In an another aspect of the invention there is provided, a method of visual programming, comprising the steps of: receiving a domain model of a software program, the model being composed of a plurality of elements that represent desired functional components of the software program; analyzing each of the elements and interrelations therebetween; determining a generation order for a set of code modules to implement the domain model as the software program; matching the analyzed elements with predefined templates of software code shells and customizing the templates according to the analyzed elements and interrelations; and, generating the set of code modules by assembling the customized templates according to the generation order.

In a particular implementation of the foregoing aspect, the elements include a set of object classes, a set of relationships and a set of attributes.

### BRIEF DESCRIPTION OF THE DRAWINGS

Preferred embodiments of the present invention will now be described, by way of example only, with reference to the attached Figures, wherein:

FIG. 1 shows a schematic representation of an apparatus for visual programming in accordance with a first embodiment of the invention;

FIG. 2 shows a number of software and hardware components that, in combination, operate on the apparatus of FIG. 1;

FIG. 3 shows a method of visual programming in accordance with an embodiment of the invention;

FIG. 4 shows an example of a visual domain model;

FIG. 5 shows a method of analyzing the object classes, attributes, persistence and relationships of a domain model in a particular implementation of the method shown in FIG. 3;

FIG. 6 shows a number of components corresponding to the graphical domain model of FIG. 4 for an exemplary enterprise application platform;

FIG. 7 shows a method of matching shells for code modules in a particular implementation of the method shown in FIG. 3;

FIG. 8 shows a method of generating code in a particular implementation of the method shown in FIG. 3;

FIG. 9 shows the layout of a code module prepared in accordance with an embodiment of the invention;

FIG. 10 shows an enterprise application platform upon which a domain model is implemented;

FIG. 11 shows a method of incorporating code customizations into the method of FIG. 3; and,

FIG. 12 shows another method of incorporating code customizations into the code generated using the method of FIG. 3.

### DETAILED DESCRIPTION OF THE INVENTION

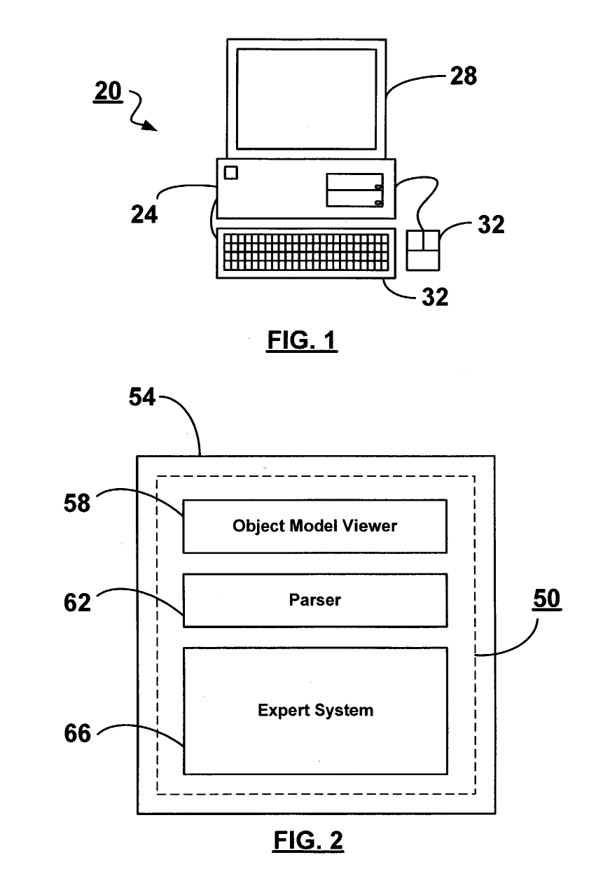

An apparatus for visual programming in accordance with an embodiment of the invention is generally shown at 20 in FIG. 1. In the present embodiment, apparatus 20 is a workstation, but can be a server, desktop computer, terminal, personal digital assistant or any computing other device. Apparatus 20 comprises a tower 24, connected to an output device 28 for presenting output to a user and one or more input devices 32 for receiving input from a user. Tower 24 typically houses at least one central processing units (“CPUs”) coupled to random access memory and permanent storage devices via a bus.

Referring now to FIG. 2, a schematic representation of visual programming software executing on one of the at least one CPUs housed within tower 24 is indicated at 50. The CPU itself is indicated at 54. In the present embodiment, visual programming software 50 is shown executing on CPU 54 of apparatus 20, however, it is to be understood that software 50 can execute on other types of computing devices that will occur to those of skill in the art.

Software 50 is comprised of an object model viewer 58, a parser 62 and an expert system 66. Object model viewer 58 is an application that receives a domain model from a user operating input devices 32 of apparatus 20, and presents that received model on output device 28 of apparatus 20. Further, object model viewer 58 allows the user to view and edit such domain models that are presented on output device 28 and create and/or modify such domain models using input devices 32 of apparatus 20. In the present embodiment, object model viewer 58 and the domain models received thereby are UML-based, but other languages suitable for allowing users to view and modify domain models can be employed as desired.

Parser 62 is an application that interprets a domain model received by object model viewer 58 by identifying the individual object classes and their attributes, and the relationships between the object classes and their attributes.

Expert system 66 is a rule-based inference engine that receives a set of parameters specifying a method of analyzing a domain model and a set of corresponding decisions that enable expert system 66 to architecturally plan and generate a set of code modules that together provide the desired functionality. These rules are generally static, but can be modified, for example, to reflect changes in the specifications for the enterprise application platform or the enterprise platform itself, or to cater to certain scenarios where differing program structures are desired. In a present embodiment of the invention, these rules are hard-coded into the logic of expert system 66, but it will be understood by those of skill in the art that expert system 66 can receive these rules in a number of other formats, such as an XML file or as one or more data objects.

Expert system 66 uses information provided by parser 62 to map the domain model received by object model viewer 58 to a series of code modules for deploying the received domain model on a specific enterprise application platform supported by expert system 66. Upon receipt of the set of rules, expert system 66 is aware of the requirements for the specific enterprise application platform and able to determine what artefacts need to be generated. As an example, where the enterprise application platform is J2EE, expert system 416 can determine from a set of corresponding rules that certain J2EE-specific artefacts need be generated from its analysis of the domain model, such as a home and component interface for each of the entity and session beans and the beans themselves, a value class, and associations between the beans.

Further, expert system 66 generates the source code for each of the code modules required to implement the domain model on a particular enterprise application platform. As the requirements and specific implementation details vary between enterprise application platforms, expert system 66 is typically designed for only one enterprise application platform, but can alternatively be designed to handle two or more enterprise application platforms.

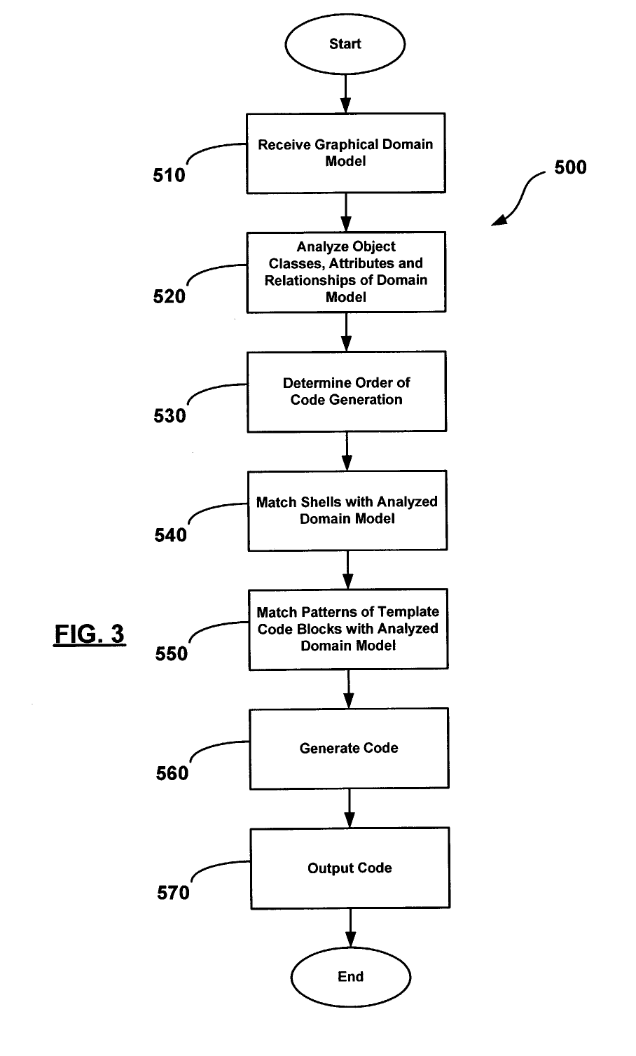

Now referring to FIG. 3, a method of visual programming is generally shown at 500. In a present embodiment, method 500 is executed on apparatus 20 executing software 50, and accordingly, the following description of method 500 will provide further understanding of apparatus 20 and software 50. However, it is to be understood that method 500 can be executed on other computing devices other than apparatus 20, and that variations of method 500 can be executed on apparatus 20 and such variations are within the scope of the present invention.

Continuing now with the explanation of method 500, beginning first at step 510, a graphical domain model is received. When step 510 is implemented on apparatus 20, object model viewer 58 receives the graphical domain model from a user using apparatus 20.

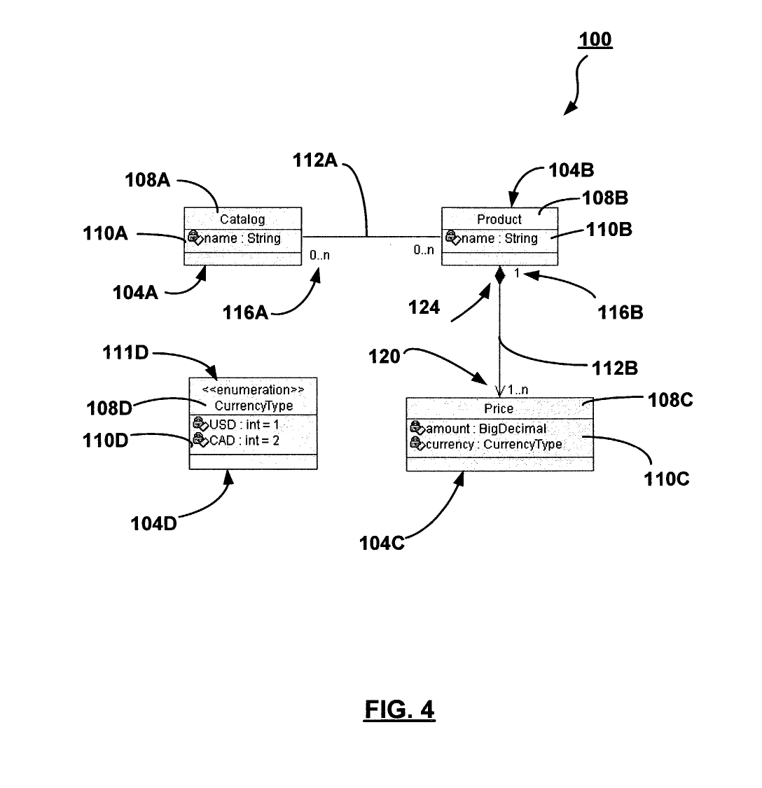

Referring now to FIG. 4, an example of a graphical domain model that can be received at step 510 is indicated generally at 100. In general, domain models will typically include a number of elements that represent desired functional components in a software program that implements the model. Such elements found in domain model 100 include a number of object classes 104, each having an object class name 108, a number of attributes 110 and potentially one or more object class type attributes 111. Attributes 110 can represent information to be represented by object classes 104. For example, in enterprise applications, attributes 110 can denote a persistent data record. Object class 104A, which represents information about a set of catalogs, is shown having an object class name 108A of “Catalog” and an attribute 110A. Attribute 110A is shown to have the label “name” and is specified to be of the type “String”, indicating that object class 104A represents textual name information for the catalogs. Similarly, object class 104B, which represents information about a set of products available through the set of catalogs, is shown having an object class name 108B of “Product” and an attribute 110B representing textual name information for the products. Object class 104C, which represents price information for the products in the catalogs, is shown having an object class name 108C of “Price” and a pair of attributes 110C. The first of attributes 110C is shown to have the label “amount” and is specified to be of the type “BigDecimal”, indicating that object class 104C represents numeric price information for the products in the catalogs. The second of attributes 110C is shown to have the label “currency” and is specified to be of the type “CurrencyType”, indicating that object class 104C can represent the price information in various currencies. “CurrencyType” is not an attribute type in the J2EE specifications and, as such, is based on further definition by the user. Object class 104D, which represents information regarding the various currencies in which pricing amounts can be maintained, is shown having an object class name 108D of “CurrencyType”, a set of attributes 110D and an object class type attribute 111D. Object class type attribute 111D provides that object class is an “enumeration” type, that, together with object class name 108D, indicates that object class 104D defines an attribute type employed in object class 104C. In this case, attributes 110D indicate the various represented values that can be assumed by the attribute type, “CurrencyType”, and are shown to have the labels “USD” and “CAD”, specified to be of the type “int=x”; where “x” represents the discrete value used to map the value maintained by the second of attributes 110C, “currency”, to either “USD” or “CAD”, in this case.

Attributes 111 can provide information regarding the object class type for each object class. In domain model 100 shown in FIG. 4, object classes 104A, 104B and 104C shown are of a standard object class type. Where object classes of non-standard object class types are to be used, their object class types can be identified by the presence of a special object class type attribute 111. As an example, object class 104D is shown having a special object class type 111D indicating that object class 104D is of the “enumeration” type. Accordingly, the object class types of object classes 104A, 104B and 104C in domain model 100 are implicit as a result of the absence of this special attribute.

It is to be understood that, where domain model 100 is to be deployed on the J2EE platform, object classes 104 can be of the persistent, transient, enumerated or other type as indicated by attribute 111 associated with object classes 104. Further, attributes 110 can either be a Java data type or a custom enumeration type. Generic object classes and attributes are referenced in the J2EE specifications, while enumerated types are user-defined.

Object classes 104 can also characterized by relationships 112 between them. In the example of FIG. 4, a number of characteristics for each relationship 112 are shown in domain model 100, namely cardinality 116, direction 120 (if any) and composition 124 (if any). Thus, cardinality 116A between object class 108A and object class 108B indicate a many-to-many relationship between classes 104A and 104B. Further, cardinality 116B indicates a one-to-one relationship between object class 104B and object class 104C. Further, the lack of arrowheads on relationship 112A indicates that there is no particular direction to the relationship between object class 104A and object class 104B. However, the presence of the arrowhead on relationship 112B indicates a specific direction 120 between object class 104A and object class 104B, whereby the information associated with object class 104C, “Price”, is not usable to link back to, or retrieve, its associated object class 108B, “Product”. Finally, composition 124, drawn as a solid diamond adjacent to object class 104B, is used to indicate lifetime dependencies. In particular, object class 104B controls the lifetime of object class 104C and, as a result, object class 104C cannot exist without object class 104B.

Object class 104D is not shown to have explicit relationships with any of object classes 104A, 104B and 104C, but it is understood by those of skill in the art that object class 104D maintains a list of possible values that can be implicitly assumed by the second of attributes 110C of object class 104C shown having a value of “CurrencyType” that is defined by object class 104D.

Overall, those of skill in the art will now appreciate that the various elements of model 100 in FIG. 4 are compliant in substance with UML, and that in general domain model 100 is a highly-abstract model that is not specific to any particular computing platform, and serves as a common “blueprint” for a number of parties that may wish to implement or generate software consistent with model 100. It is to be thus understood that the domain model can be represented in other graphical or visual languages, as desired, and it is to be reiterated that model 100 is merely exemplary, and other models 100 can be received at step 510, as desired.

Referring back again to FIG. 3, having received the model at step 510, the method advances to step 520 at which point the received domain model is analyzed. Such analysis involves a deconstruction of the particular elements and features that are generated by the modeling language used to actually create the model. Thus, when implemented on apparatus 20, step 520 is implemented by parser 62, which analyzes domain model 100 and its object classes 104 to determine the object class names 108, attributes 110, object class type attributes 111 and the characteristics of the indicated relationships therebetween.

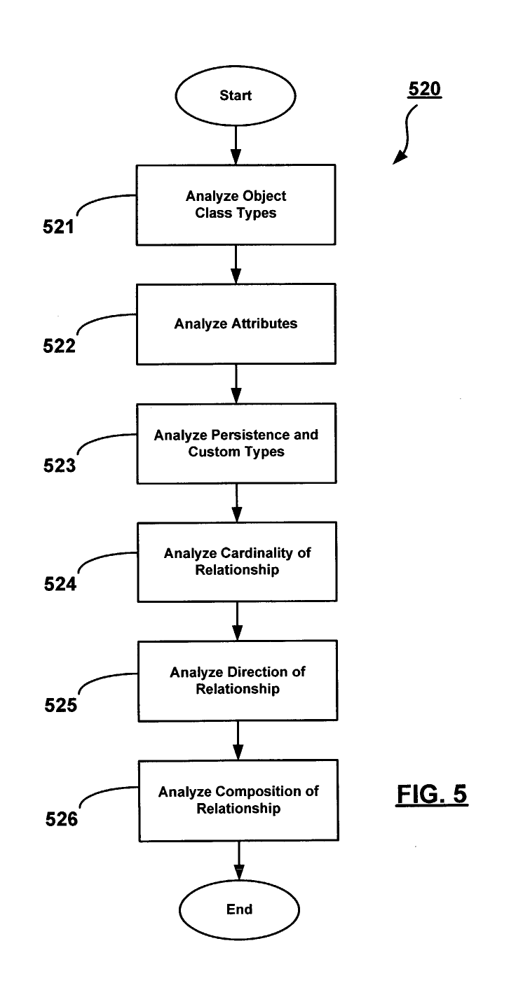

An exemplary method of analyzing domain model 100 (corresponding with the features of the UML used to generate model 100) is indicated generally at 520 in FIG. 5. At step 521, parser 62 analyzes the object class types for object classes 104. Parser 62 uses the information provided by object class type attribute 111 or a lack thereof for each object class to analyze the object class type for object classes 104. At step 522, parser 62 analyzes attributes 110 of object classes 104. At step 523, parser 62 analyzes the persistence of object classes 104. At step 524, parser 62 analyzes cardinality 116 of relationships 112 between object classes 104. At step 525, parser 62 analyzes direction 120 of relationships 112 between object classes 104. At step 526, parser 62 analyzes composition 124 of relationships 112 between object classes 104.

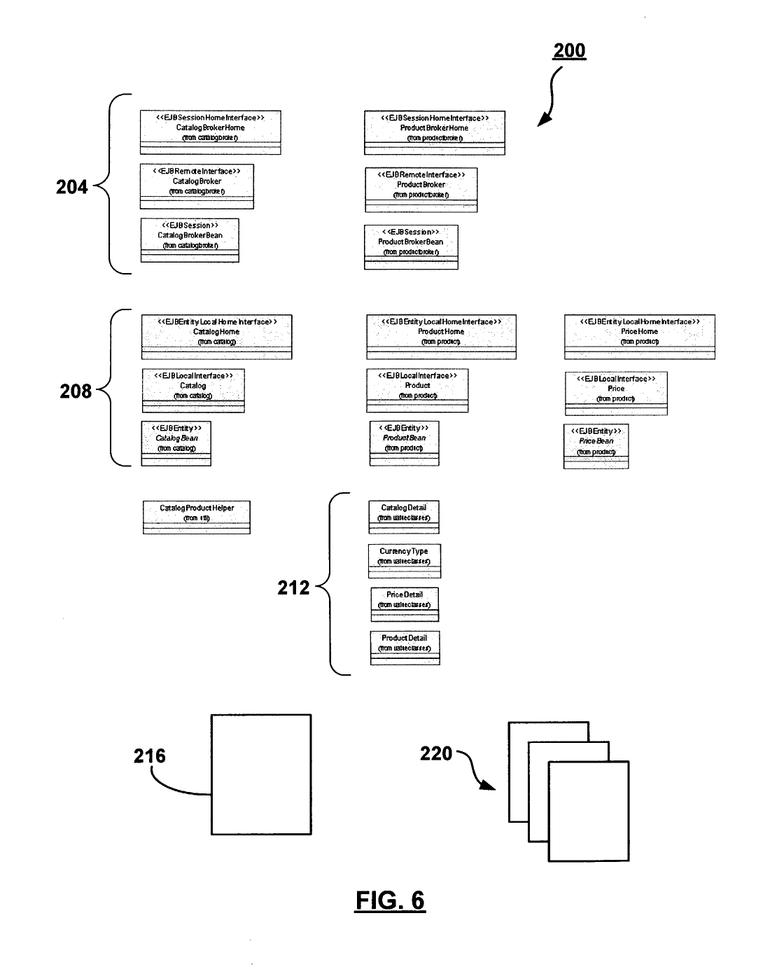

An exemplary representation of a J2EE platform-specific low-level model that is implicitly derived as a result of the analysis performed using the method shown in FIG. 5 is generally shown at 200 in FIG. 6. However, it is to be understood that low-level model 200 is shown here for illustrative purposes only, and in the present embodiment model 200 is not explicitly generated and outputted to a user. Model 200 includes a representation of a plurality of code modules that will be generated using the remaining steps of method 500. Accordingly, model 200 includes for object classes 104 represented in domain model 100:

J2EE session bean and implementations therefor, indicated at 204;

J2EE entity bean and implementations therefor, indicated at 208;

a set of data transfer object classes, indicated at 212;

one database schema file 216; and

a number of deployment descriptor files 220,

all of which are derived as a result of the analysis at step 520 in order to eventually build a complete deployment package for domain model 100. (Those of skill in the art will now recognize that, as platform-specific model 200 closely resembles the artefacts required to implement domain model 100 on a particular enterprise application platform, platform-specific model can be referred to as an “implementation-level model”. As such, platform-specific model 200 is said to be less abstract than domain model 100.)

The forgoing analyses resulting from the method shown in FIG. 5 are then passed back to step 530 in FIG. 3.

Referring again to FIG. 3, at step 530, expert system 66 determines the order of code generation. As domain model 100 typically consists of related object classes 104, expert system 66 performs a dependency analysis to determine the order in which the code modules noted in FIG. 6 are to be created. Criteria used to determine the order in which code modules are generated can arise from domain model 100 itself and the particular enterprise application platform for which the code modules are being generated. Other criteria for determining the order of code generation will occur to those of skill in the art.

At step 540, expert system 66 matches the types of analyzed domain model 100 with shells for program code. Shells are empty code modules used to form the basis for the desired code modules to provide at least a portion of an application. When the present invention is implemented using J2EE, the shells may form the basis for Java class code modules, deployment descriptors and database schema. When implemented on other types of programming environments, the particular types of shells will correspond with that particular environment.

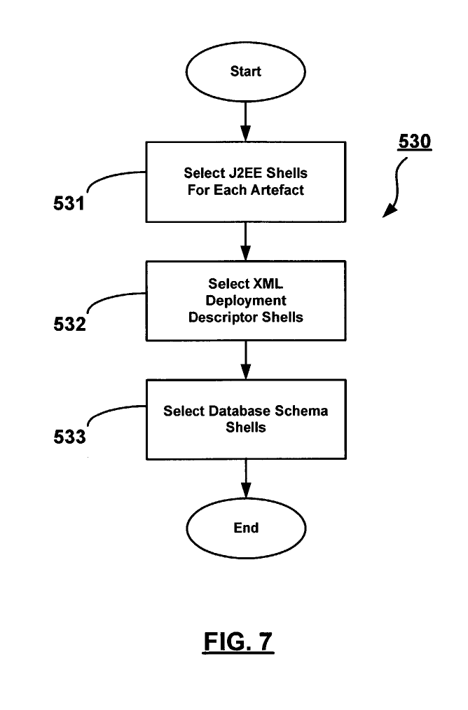

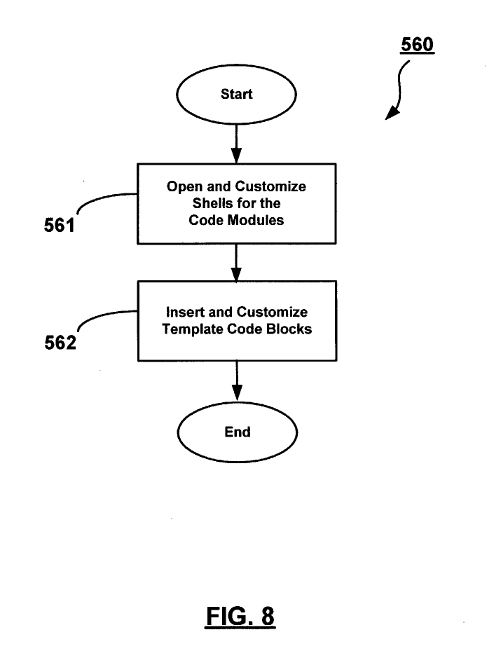

An exemplary method of performing step 540 when using J2EE is shown in FIG. 7. In such a case, the shells are matched for the following represented in FIG. 6:

each entity bean and implementations therefor,

each session bean and implementations therefor,

the XML-based deployment descriptor, and

the database schema.

For J2EE implementations of domain model 100, each domain class can potentially be mapped to seven J2EE implementation classes: the home and component interfaces for each of the entity and session beans and the beans themselves, and a value class that is transmitted across networks. There are presently three deployment descriptor files, one for deployment of domain model 100 on an EJB version 2.0-compliant EJB container and two additional ones for deployment of domain model 100 on BEA Systems' WebLogic EJB containers, and one file for the database schema.

Referring again to FIG. 3, at step 550, supported programming patterns of template code blocks are matched with the analyzed objects and relationships from step 520. When step 550 is implemented on apparatus 20 using model 100, expert system 66 matches analyzed attributes 110, object class type attributes 111 and persistence of object classes 104, and the characteristics of cardinality 116, direction 120 and composition 124 for relationships 112 indicated between object classes 104 with programming patterns. Programming patterns include one or more template code blocks that, when inserted into the appropriate shells, combine to provide the features and/or functionality required. These programming patterns represent the knowledge used by programmers to manually add various features to the shells. Expert system 66 applies these patterns in the same manner a programmer would. For example, when container-managed persistence or container-managed relationships are programmed for a J2EE application, a set of template code blocks are inserted in a number of shells for the deployment descriptor and one or more entity beans, session beans and implementations therefor. Typically, the template code blocks do not vary significantly and are usually inserted in the same places in the appropriate shells. As a result, there are a number of “patterns” for inserting template code blocks in a number of places to effect various features in the resulting application. In a present embodiment, by using standardized (supported) patterns for programming, code modules are made more readable by other programmers. As used herein, “supported” means generally accepted in the art.

At step 560, expert system 66 generates the code modules based on the code generation order determined at step 530. An exemplary method of performing step 560 is shown in FIG. 8. At step 561, expert system 66 opens the selected shells chosen from a library of available shells at step 540 for each required artefact and customizes them as required. At step 562, expert system 66 inserts the template code blocks selected at step 540 into the shells customized at step 561 and customizes the inserted template code blocks.

Once the template code blocks have been inserted into the shells and both have been customized to form the desired code modules, the code is outputted at step 570. In the present embodiment of the invention, the generated code modules are saved to a storage device to allow a developer to further customize them by inserting additional business logic prior to compiling the code modules for deployment on an enterprise application platform such as system 900. Alternatively, the generated code modules are immediately compiled to produce binary code that is deployable on an enterprise application platform such as system 900, can be transmitted to another computing device or can be presented to a user via output device 28 or a printer (not shown). Other manners of outputting the code will occur to those of skill in the art. Upon executing step 570, method 500 is complete.

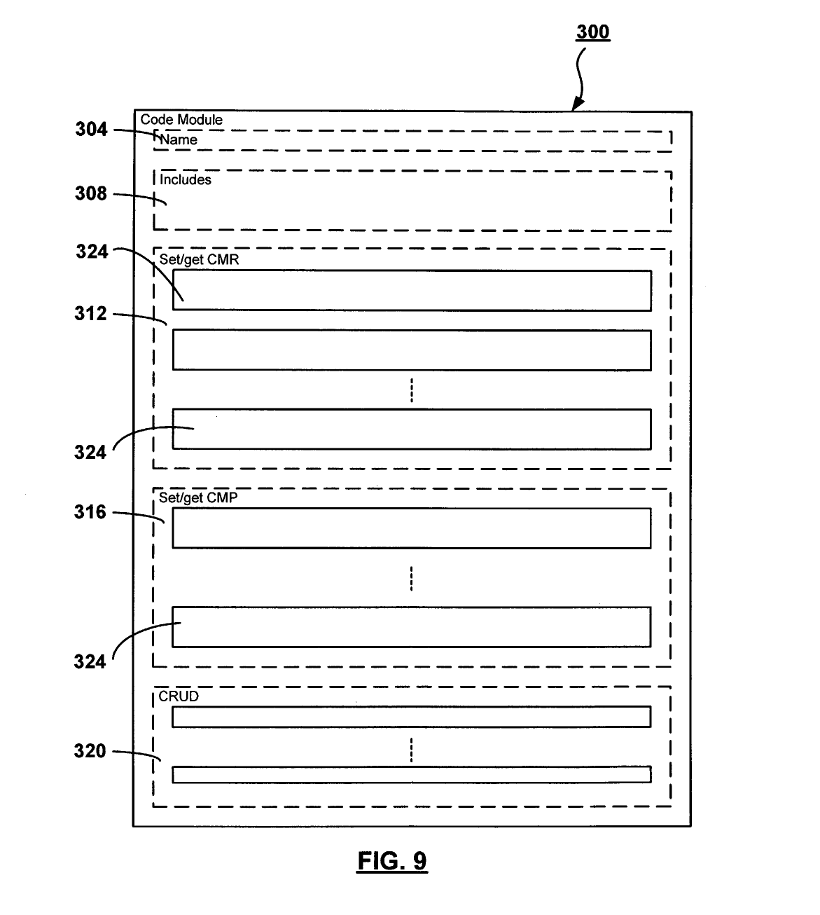

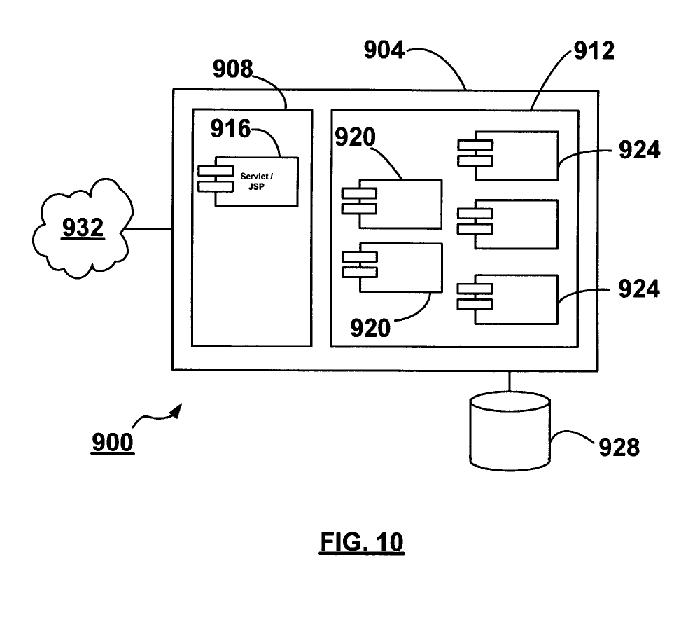

Referring now to FIG. 9, a layout of an exemplary source code module that is generated as a result of method 500 is indicated generally at 300. For the purpose of illustration, source code module 300 is the source code for the entity bean of an EJB to be deployed on a J2EE platform. Source code module 300 typically has a name declaration 304 and can also comprise a number of include methods 308, a set of abstract set/get relationship methods 312, a set of abstract set/get attribute statements 316 and a set of create, remove, update and delete (“CRUD”) methods 320 for managing instances. While not shown in FIG. 4, those of skill in the art will recognize a set of statements for managing associations is generated for each association instance. These statements enforce the association constraints as defined in the domain model. Other statements for the implementation of pattern based functions are also generated, as will be understood by those of skill in the art. The sets of relationship and attribute statements 312 and 316, as defined in the J2EE Specifications and code blocks that use the above to implement usable functions based on best practice patterns, are comprised of one or more code blocks 324. In general, it is to be understood that the specific contents of source code module 300 are consistent with model 100 while remaining compliant with the many different aspects of J2EE.

Once the code (i.e. such as code module 300) has been generated from the domain model using the method of FIG. 5, it can be compiled and deployed immediately. Referring now to FIG. 10, a representation of the J2EE platform upon which the code modules, including code module 300, representing domain model 100 is indicated generally at 900. Platform 900 consists of a J2EE server 904 having a presentation tier 908 and an EJB container 912. Presentation tier 908 and EJB container 912 are collections of components that provide predetermined functionality for J2EE server 904. Both presentation tier 908 and EJB container 912 can be executed in a single Java Virtual Machine (JVM) or can be segregated into separate JVMs, on separate physical machines, or can be individually distributed across more than one machine, as desired according to the particular chosen platform for deployment. Presentation tier 908 contains a servlet and/or JSPs 916 in communication with a number of application components 920 residing in EJB container 912. Application components 920 serve to provide the majority of the functionality and business logic of the application executing on platform 900. Application components 920 are in communication with a number of data object classes 924 in EJB container 912. Overall, model 100 as implemented in the components 920, data object classes 924 and other elements of platform 900 will be consistent with the structure of data in database 928. Data object classes 924 and database schema corresponding to database 928 are thus complementary to object classes 104 in model 100 of FIG. 4. As shown in FIG. 10, platform 900 is also connected to a network 932 operable to receive code and other information.

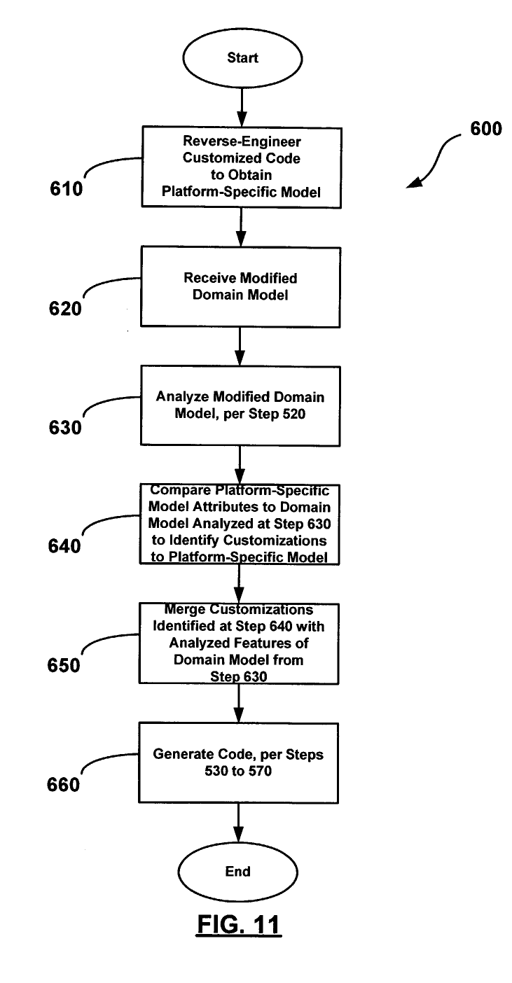

While code module 300 can be directly deployed onto platform 900, it is also contemplated that manual customizations can be effected to module 300. FIG. 11 shows a method of customizing program code.

At step 610, code representing an enterprise application that contains a set of one or more customizations is reverse-engineered to obtain a platform-specific model. The customizations can include, for example, the addition of a parameter to the arguments of a function call. In a present embodiment, the code modules previously generated using method 500 (i.e. such as code module 300) from a domain model such as domain model 100 and then customized are reverse-engineered using a reverse-engineering tool, such as the commercial software package, Rational Rose. The reverse-engineering process produces a platform-specific model of a desired level of abstraction. Such a platform-specific model could appear, for example, similar to model 200 of FIG. 6. It is contemplated, however, that the code can be generated using any appropriate method and any suitable software can be used to reverse-engineer the code to obtain a platform-specific model suitable for modification.

A set of one or more modifications made to a domain model representing the application represented by the code reverse-engineered at step 610 are received at step 620. In the present embodiment, changes are made to the domain model from which the customized code was originally generated using method 500.

At step 630, the modified domain model received at step 620 is analyzed in accordance with step 520 of method 500.

Then, at step 640, the features of the platform-specific model generated at step 610 are compared to the features of the modified domain model analyzed at step 630 to identify the customizations present in the code reverse-engineered at step 610.

At step 650, the features of the domain model analyzed at step 630 are modified to incorporate the customizations present in the reverse-engineered code and identified at step 640.

At step 660, modified code is generated in accordance with steps 530 to 570 of method 500 from the domain model features analyzed at step 630 and modified at step 650. At this point, the method is complete.

It will occur to those of skill in the art that step 610 can be performed before or after steps 620 and 630.

By enabling a developer to make modifications to the code that can be readily incorporated into further iterations of code generated from the domain model, the time required to develop code and the risk of manual coding errors can be reduced. Those of skill in the art will now recognize that the process outlined in method 600 is a form of round-trip engineering, in contrast to another approach to software development involving a progression from a highly-abstract model to the actual code required to implement the model.

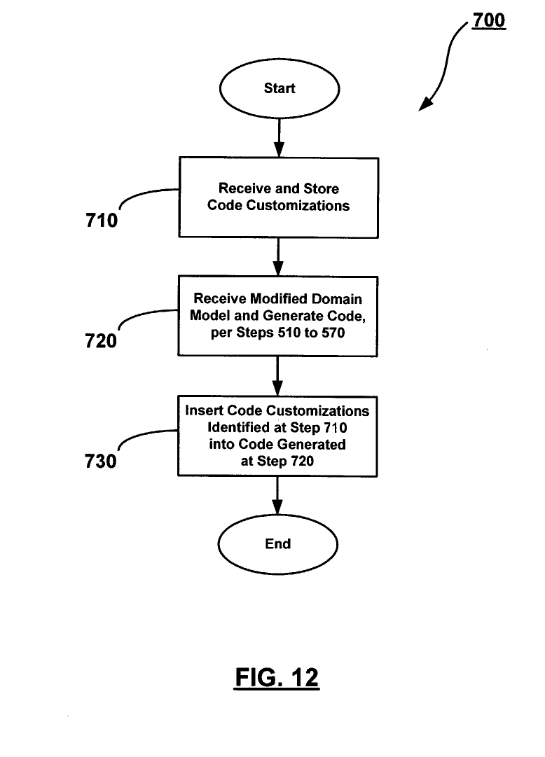

As is often the case, however, modifications made to the code for business logic providing functionality for an enterprise application are typically lost during the process of round-trip engineering. In such a process of round-trip engineering, the code originally generated and customized is discarded in favor of a newly-generated set of code. In such cases, any customizations made to the code are lost. Generally, these customizations represent business logic that is not entered into the domain model or the platform-specific model, but is manually programmed in the code. Accordingly, a method of maintaining customizations made to program code while performing round-trip engineering is shown generally at 700 in FIG. 12.

At step 710, a set of customizations made to a set of code comprising at least a portion of an enterprise application is received and stored. Typically, these customizations correspond to the addition of business logic to code generated using a method such as method 500. The storage of these customizations can be performed in a number of ways, including the retention of a backup copy of the customized code and the identification and retention of the individual code customizations. Other methods of storing these code customizations will occur to those of skill in the art.

At step 720, a domain model corresponding to the set of code that was previously customized and that has been modified is received and code is generated in accordance with method 500. In the present embodiment, the domain model is the same as was previously used to generate the set of code using method 500 that was customized and received at step 710.

Then, at step 730, the code customizations stored at step 710 are then inserted into the set of code generated at step 720. Where a copy of the original code was simply retained at step 710, the copy is reviewed to identify customizations. In the present embodiment, customizations are inserted between distinct comment lines in the code at step 710, the code being preferably generated using a method such as method 500. In this manner, the identification of code customizations is facilitated. Further, identified customizations can be reinserted in like positions between comment lines in the code generated at step 720. Upon reinsertion of the customizations into the code, the method of maintaining customizations made to the code while performing round-trip engineering is complete.

While the embodiments discussed herein are directed to specific implementations of the invention, it will be understood that combinations, sub-sets and variations of the embodiments are within the scope of the invention. For example, the invention can be used for preparing code to be used on any enterprise application platform. Further, any modeling language that is appropriate for modeling a domain model can be employed.

It is also to be understood that the sequence of steps of the methods discussed in the embodiments herein need not be conducted in the order as shown, and that other sequences of performing those steps can be effected as desired.

Although the domain model of FIG. 4 is shown with specificity to the Java environment, it is to be understood by those of skill in the art that models particular to other enterprise application environments can be employed. Further, fully platform-agnostic domain models can also be used. In such cases, expert system 66 must be provided a set of rules for matching features of domain model 100 with the appropriate enterprise application-specific features. For example, where an attribute of the domain model is specified to be of the type “text” (which can be selected to denote a string of one or more characters) and where expert system 66 is programmed to map domain model 100 onto the Java environment, the rules received by expert system 66 can map this attribute type to “String”.

Although the domain model of FIG. 4 is shown with particular elements, it is to be understood by those of skill in the art that other elements and features of domain models can be processed by the present invention. For example, additional features of the object classes and relationships therebetween can be stored by the model but not displayed, such as possible using UML Object Constraint Language. In such cases, a user can view and change these features by right-clicking on the appropriate portion of the model to bring up a dialog box or other window.

It will be understood by those of skill in the art that certain variations in the order of the steps of the method shown in FIG. 3 that yield the desired result are also within the scope of the invention.

The above-described embodiments of the invention are intended to be examples of the present invention and alterations and modifications may be effected thereto, by those of skill in the art, without departing from the scope of the invention which is defined solely by the claims appended hereto.

We claim:

1. A method of visual programming, comprising the steps of:
receiving a domain model representing a set of object classes, a set of relationships and a set of attributes;
analyzing each of said object classes, relationships and attributes;
matching said analyzed object classes with at least one corresponding shell;
matching said analyzed relationships and said attributes with at least one corresponding template code block respective to said matched shells; and,
determining a generation order for a set of code modules to implement said domain model;
generating said set of code modules by inserting said at least one template code block into said shells according to said generation order.

2. The method of visual programming of claim 1, wherein said set of attributes includes at least one attribute that is implicitly defined.

3. The method of visual programming of claim 1, wherein said domain model is modeled via the Unified Modeling Language.

4. The method of visual programming of claim 1, wherein said step of analyzing each of said object classes, attributes and relationships comprises the steps of:
analyzing the types of said object classes;
analyzing said attributes of said object classes;
analyzing the persistence of said object classes;
analyzing the cardinality of said relationships;
analyzing the direction of said relationships; and,
analyzing the composition of said relationships.

5. The method of visual programming of claim 1, wherein said code modules implement said domain model on the Java 2 Enterprise Edition platform.

6. The method of visual programming of claim 5, wherein said step of matching each of said object classes comprises the steps of:
selecting at least one of said shells to implement each of a set of EJBs associated with said object classes;
selecting at least one of said shells to implement a deployment descriptor; and,
selecting at least one of said shells to implement a database schema.

7. The method of visual programming of claim 1, wherein the step of generating said set of code modules comprises the steps of:
opening and customizing said shells for said code modules; and,
inserting and customizing said at least one template code block into said shells.

8. The method of visual programming of claim 1, wherein said code modules consist of executable code.

9. The method of visual programming of claim 1, wherein all code modules required to implement said domain model are generated in said step of generating said set of code modules.

10. The method of developing software of claim 1, comprising the additional steps of:
reverse-engineering said set of code modules, said code modules having been customized after said step of generating said set of code modules, to obtain a platform-specific model consisting of a customized set of object classes, relationships and attributes;
receiving a set of modifications to said domain model, said modified model having a modified set of object classes, relationships and attributes;
analyzing said each of said modified set of object classes, relationships and attributes of said modified domain model;
comparing said modified set of object classes, relationships and attributes of said modified domain model to said customized set of object classes, relationships and attributes to identify a set of customizations;
merging said set of customizations with said modified set of object classes, relationships and attributes of said modified domain model to produce a customized modified set of object classes, relationships and attributes; and,
generating a set of customized modified code modules by performing said steps of determining a generation order, matching said object classes, matching said analyzed relationships, and generating said set of code modules for said customized modified set of object classes, relationships and attributes.

11. The method of developing software of claim 10, wherein said domain model is modeled via the Unified Modeling Language.

12. The method of developing software of claim 10, wherein the step of reverse-engineering is performed using a commercial software package.

13. The method of visual programming of claim 1, comprising the additional steps of:
receiving and storing a set of customizations made to said code modules;
receiving a set of modifications to said domain model, said modified domain model having a modified set of object classes, relationships and attributes, and generating a modified set of code modules in accordance with the steps of analyzing each of said modified object classes, relationships and attributes, determining a modified generation order for said modified set of code modules, matching said analyzed modified object classes, relationships and attributes, and generating said modified set of code modules; and,
inserting said set of customizations into said modified code modules.

14. The method of maintaining code customizations of claim 13, wherein said customizations are located between a set of custom comment lines pre-existing in said code modules.

15. The method of maintaining code customizations of claim 13, wherein said customizations are located between a set of custom comment lines added to said code modules during customization.

16. The method of maintaining code customizations of claim 13, wherein said customizations are stored by storing said code modules.

17. An apparatus for visual programming, comprising:
a computing device having a central processing unit (CPU), a data storage device for exchanging non-volatile data with said CPU, random access memory (RAM) for exchanging volatile data with said CPU, and an input interface for receiving data for said CPU and an output interface for presenting outputted data from said CPU;
said CPU and RAM operable to receive a domain model via said input interface, said domain model being comprised of a set of object classes, a set of relationships and a set of attributes;
said CPU being operable to analyze each of said object classes, said attributes and said relationships according to a modeling language used to create said model, said elements being stored in said data storage device and accessible by said CPU;
said CPU further operable to determine a generation order for a set of code modules to implement said domain model;
said CPU further operable to match said object classes with at least one corresponding shell stored in said data storage device and accessible by said CPU;
said CPU further operable to match said analyzed relationships and said analyzed attributes with at least one corresponding template code block respective to said matched shells, said at least one template code block stored in said data storage device and accessible by said CPU; and,
said CPU further operable to generate said set of code modules by inserting said template code blocks into said respective shells according to said generation order, and output said generated code modules to at least one of said output interface and said data storage device.

18. The apparatus for visual programming of claim 17, wherein said computing device is operable to receive said domain model as a graphical representation.

19. The apparatus for visual programming of claim 17, wherein said code modules implement said domain model on a Java 2 Enterprise Edition platform.

20. The apparatus for visual programming of claim 17, wherein said computing device is operable to store said code modules on said data storage device.

21. The apparatus for visual programming of claim 17, wherein said computing device is operable to compile said code modules to produce executable code.

22. The apparatus for visual programming of claim 17, wherein all code modules required to implement said domain model are generated by said CPU.

23. A method of visual programming, comprising the steps of:
receiving a domain model representing a set of object classes and a set of relationships therebetween, said sets of object classes and relationships having a set of attributes;
analyzing each of said object classes, attributes and relationships;
determining a generation order for said code modules and said template code blocks to be inserted therein;
matching each of said object classes to at least one shell, each of said shells forming a basis for one of a set of code modules for implementation of said domain model;
matching said attributes and said relationships with at least one template code block for insertion into said shells; and,
generating said set of code modules by inserting said template code blocks into said shells according to said generation order.

24. A method of visual programming, comprising the steps of:
receiving a domain model including a plurality of elements that represent functional components of a software program;
analyzing each of said elements and interrelations therebetween;
matching said analyzed elements with predefined templates of software code shells and customizing said templates according to said analyzed elements and interrelations; and,
generating said set of code modules by assembling said customized templates according to a determined generation order.

25. The method according to claim 24 wherein said elements include a set of object classes, a set of relationships and a set of attributes.

26. The method according to claim 25 wherein said matching step comprises the following sub-steps:
matching said analyzed object classes with at least one corresponding shell; and,
matching said analyzed relationships and said attributes with at least one corresponding template code block respective to said matched shells.
